(19) United States
(12) Patent Application Publication
(10) Pub. No.: US 2025/0283723 A1
(43) Pub. Date: Sep. 11, 2025

(54) VEHICLE DISPLAY CONTROL DEVICE, VEHICLE DISPLAY CONTROL METHOD, AND VEHICLE DISPLAY CONTROL PROGRAM

(71) Applicant: TOYOTA JIDOSHA KABUSHIKI KAISHA, Toyota-shi (JP)

(72) Inventor: Miki TSUJINO, Nagakute-shi (JP)

(73) Assignee: TOYOTA JIDOSHA KABUSHIKI KAISHA, Toyota-shi (JP)

(21) Appl. No.: 19/010,360

(22) Filed: Jan. 6, 2025

(30) Foreign Application Priority Data
Mar. 6, 2024 (JP) 2024-034368

(51) Int. Cl. G01C 21/28; G06T 11/20; G07C 5/04

(52) U.S. Cl. CPC G01C 21/28; G06T 11/203; G07C 5/04

(57) ABSTRACT

The vehicle display control device acquires driving history data of the host vehicle. The vehicle display control device changes a stage of a change in curvature of a curved road drawn in an image imitating the traveling road in accordance with the driving history data when the traveling road on which the host vehicle travels is a curved road. Then, the vehicle display control device causes the display unit to display an image of the traveling road corresponding to the curved road on which the host vehicle travels, together with an image of the host vehicle, in the changed stage.

### CROSS-REFERENCE TO RELATED APPLICATION

This application claims priority to Japanese Patent Application No. 2024-034368 filed on Mar. 6, 2024, incorporated herein by reference in its entirety.

### BACKGROUND

### 1. Technical Field

The present disclosure relates to a vehicle display control device, a vehicle display control method, and a vehicle display control program.

### 2. Description of Related Art

Japanese Unexamined Patent Application Publication No. 2022-41244 (JP 2022-41244 A) discloses an in-vehicle display device. The in-vehicle display device acquires information on peripheral objects present around a host vehicle. The in-vehicle display device suppresses displaying, on a head-up display, images of the peripheral objects other than a first preceding vehicle traveling ahead in a lane in which the host vehicle is traveling, out of the images of the peripheral objects on which the information has been acquired. The in-vehicle display device of JP 2022-41244 A displays the first preceding vehicle on a meter display, and displays the other peripheral objects while reducing the color tones stepwise depending on importance levels.

### SUMMARY

It is assumed that, when the traveling road on which the host vehicle travels is a curved traveling road (hereinafter simply referred to as “curved road”), an image imitating the traveling road is displayed on a display unit in the host vehicle. In this case, even if the image is displayed on the display unit in the host vehicle with the curvature approximated to the curvature of the actual curved road, the appearance of the curved road varies depending on the occupant. Thus, the occupant of the host vehicle may feel uncomfortable.

The in-vehicle display device disclosed in JP 2022-41244 A suppresses displaying, on the head-up display, the images of the peripheral objects other than the first preceding vehicle traveling ahead in the lane in which the host vehicle is traveling. Along with this control, the in-vehicle display device displays the first preceding vehicle on the meter display, and displays the other peripheral objects while reducing the color tones stepwise depending on the importance levels.

However, JP 2022-41244 A does not take into consideration the point that the curvature of the curved road shown in the image imitating the traveling road is changed.

The present disclosure provides a vehicle display control device that reduces an uncomfortable feeling of an occupant of a host vehicle when presenting an image showing a surrounding situation of the host vehicle to the occupant in a situation in which the host vehicle travels on a curved road. The present disclosure provides a vehicle display control method that reduces an uncomfortable feeling of an occupant of a host vehicle when presenting an image showing a surrounding situation of the host vehicle to the occupant in a situation in which the host vehicle travels on a curved road. The present disclosure provides a vehicle display control program that reduces an uncomfortable feeling of an occupant of a host vehicle when presenting an image showing a surrounding situation of the host vehicle to the occupant in a situation in which the host vehicle travels on a curved road.

A vehicle display control device according to a first aspect includes: an acquisition unit configured to acquire driving history data of a host vehicle; and a display control unit configured to, when a traveling road on which the host vehicle travels is a curved road, change stages of variation in a curvature of the curved road to be shown in an image imitating the traveling road according to the driving history data, and causes a display unit to display, together with an image imitating the host vehicle, an image imitating the traveling road that is associated with the curved road on which the host vehicle travels among the changed stages.

The vehicle display control device according to the first aspect acquires the driving history data of the host vehicle. When the traveling road on which the host vehicle travels is a curved road, the vehicle display control device changes the stages of the variation in the curvature of the curved road to be shown in the image imitating the traveling road according to the driving history data. The vehicle display control device causes the display unit to display, together with the image imitating the host vehicle, the image imitating the traveling road that is associated with the curved road on which the host vehicle travels among the changed stages. Accordingly, it is possible to reduce the uncomfortable feeling of the occupant of the host vehicle when presenting the image showing the surrounding situation of the host vehicle to the occupant in the situation in which the host vehicle travels on the curved road.

In the vehicle display control device according to the first aspect,
the driving history data may be history data of steering operations of a driver for the host vehicle, and
the display control unit may be configured to change the stages of the variation in the curvature based on the history data of the steering operations.

Accordingly, it is possible to reproduce the curvature of the curved road according to the degree of the steering operation of the driver of the host vehicle.

In the vehicle display control device according to the first aspect, the driving history data may be history data of traveling roads on which the host vehicle has traveled, and
the display control unit may be configured to change the stages of the variation in the curvature based on the history data of the traveling roads.

Accordingly, it is possible to reproduce the curvature of the curved road according to the traveling history of the host vehicle.

A vehicle display control method according to a second aspect includes causing a computer to execute a process including:
acquiring driving history data of a host vehicle; and
when a traveling road on which the host vehicle travels is a curved road, changing stages of variation in a curvature of the curved road to be shown in an image imitating the traveling road according to the driving history data, and causing a display unit to display, together with an image imitating the host vehicle, an image imitating the traveling road that is associated with the curved road on which the host vehicle travels among the changed stages. Accordingly, it is possible to reduce the uncomfortable feeling of the occupant of the host vehicle when presenting the image showing the surrounding situation of the host vehicle to the occupant in the situation in which the host vehicle travels on the curved road.

A vehicle display control program according to a third aspect is
a vehicle display control program for causing a computer to execute a process including:
acquiring driving history data of a host vehicle; and
when a traveling road on which the host vehicle travels is a curved road, changing stages of variation in a curvature of the curved road to be shown in an image imitating the traveling road according to the driving history data, and causing a display unit to display, together with an image imitating the host vehicle, an image imitating the traveling road that is associated with the curved road on which the host vehicle travels among the changed stages. Accordingly, it is possible to reduce the uncomfortable feeling of the occupant of the host vehicle when presenting the image showing the surrounding situation of the host vehicle to the occupant in the situation in which the host vehicle travels on the curved road.

With the vehicle display control device of the present disclosure, it is possible to reduce the uncomfortable feeling of the occupant of the host vehicle when presenting the image showing the surrounding situation of the host vehicle to the occupant in the situation in which the host vehicle travels on the curved road. With the vehicle display control method of the present disclosure, it is possible to reduce the uncomfortable feeling of the occupant of the host vehicle when presenting the image showing the surrounding situation of the host vehicle to the occupant in the situation in which the host vehicle travels on the curved road. With the vehicle display control program of the present disclosure, it is possible to reduce the uncomfortable feeling of the occupant of the host vehicle when presenting the image showing the surrounding situation of the host vehicle to the occupant in the situation in which the host vehicle travels on the curved road.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram for explaining a schematic configuration of a display control system for a vehicle according to an embodiment;

FIG. 2 is a block diagram illustrating a functional configuration of the vehicle display control device according to the embodiment;

FIG. 3 is a diagram illustrating an example of an image shown in a display unit;

FIG. 4 is a diagram for explaining a curved path drawn in an image simulating a traveling path;

FIG. 5A is a diagram illustrating a step of a change in curvature of a curved path;

FIG. 5B is a diagram illustrating a step of a change in curvature of a curved path;

FIG. 5C is a diagram for explaining a step of a change in curvature of a curved path; and

FIG. 6 is a diagram illustrating an example of a flowchart executed by the vehicle display control device.

### DETAILED DESCRIPTION OF EMBODIMENTS

### First Embodiment

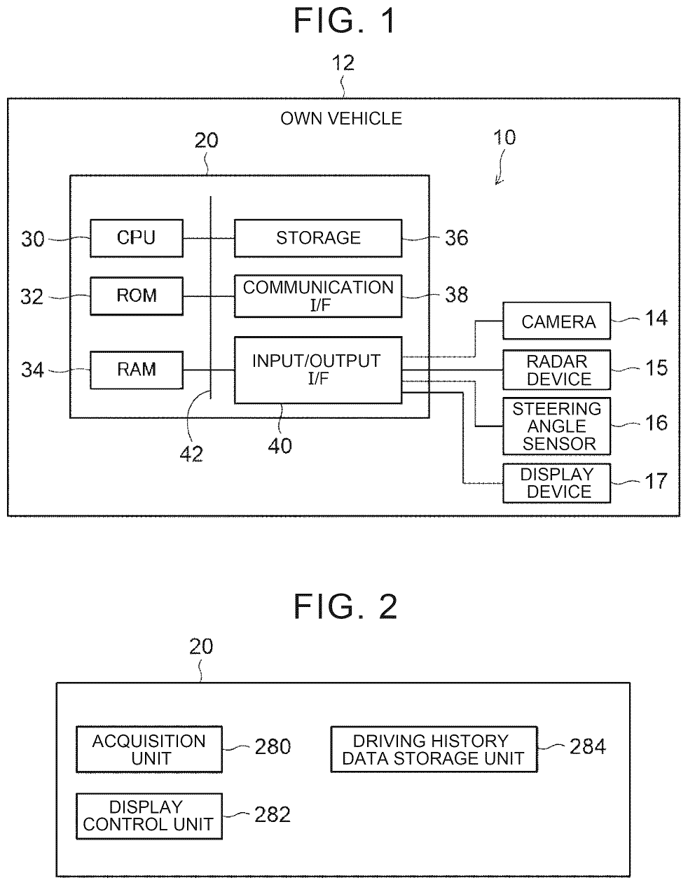

FIG. 1 is a schematic configuration diagram of a vehicle display control system 10 according to a first embodiment. As shown in FIG. 1, the vehicle display control system 10 is mounted on the host vehicle 12. As illustrated in FIG. 1, the vehicle display control system 10 includes a camera 14, a radar device 15, a steering angle sensor 16, a display device 17, and a vehicle display control device 20.

The camera 14 captures an image of the surroundings of the host vehicle and outputs the captured image.

The radar device 15 detects, as point group information, various objects such as a surrounding vehicle existing in the vicinity of the host vehicle 12.

The steering angle sensor 16 detects the steering angle θ of the steering operation of the host vehicle 12.

The display device 17, which is an example of the display unit, is, for example, a meter display, a head-up display, a car navigation display, or the like.

The vehicle display control device 20 is, for example, an electronic control unit (ECU) that performs various controls. The vehicle display control device 20 displays, on the display device 17 around the driver's seat, an image indicating the surrounding situation of the host vehicle, which is assumed to be viewed from the virtual viewpoint. Hardware configuration of the vehicle display control device 20

As shown in FIG. 1, the vehicle display control device 20 includes a central processing unit (CPU: processor) 30. The vehicle display control device 20 includes Read Only Memory (ROM) 32 and Random Access Memory (RAM) 34. The vehicle display control device 20 includes a storage 36, a communication interface (communication I/F) 38, and an input/output interface (input/output I/F) 40. The components are communicably connected to each other via an internal bus 42.

CPU 30 is a central processing unit that executes various programs and controls each unit. That is, CPU 30 reads the program from ROM 32 or the storage 36, and executes the program using RAM 34 as a working area. In addition, CPU 30 performs control of the above-described configurations and various arithmetic processes in accordance with programs recorded in ROM 32 or the storage 36.

ROM 32 stores various programs and various data. RAM 34 temporarily stores a program/data as a working area. The storage 36 is configured by hard disk drive (HDD) or solid state drive (SSD). The storage 36 is a non-transitory recording medium that stores various programs including an operating system and various data. In the present embodiment, ROM 32 or the storage 36 stores a vehicle display control program or the like for performing a display process or the like.

The communication interface 38 is an interface for the vehicle display control device 20 to communicate with the server and other devices. The communication interface 38 is realized according to a technique using a standard such as Controller Area Network (CAN), Ethernet (registered trademark), or Long Term Evolution (LTE), for example. The communication interface 38 is realized according to a technique using a standard such as Fiber Distributed Data Interface (FDDI) or Wi-Fi (registered trademark).

The camera 14, the radar device 15, the steering angle sensor 16, and the display device 17 are connected to the input/output interface 40.

### Functional Configuration of the Vehicle Display Control Device 20

The vehicle display control device 20 realizes various functions using the above-described hardware resources. A functional configuration realized by the vehicle display control device 20 will be described with reference to FIG. 2.

As illustrated in FIG. 2, the vehicle display control device 20 includes an acquisition unit 280, a display control unit 282, and a driving history data storage unit 284 as a functional configuration. The respective functional configurations are realized by CPU 30 reading and executing a program stored in ROM 32 or the storage 36.

The acquisition unit 280 acquires an image captured by the camera 14, point cloud information detected by the radar device 15, and a steering angle θ acquired by the steering angle sensor 16.

The display control unit 282 generates an image representing the surrounding situation of the host vehicle 12 based on the surrounding information including the image acquired by the acquisition unit 280 and the point group information. Then, the display control unit 282 causes the display device 17 to display an image representing the surrounding situation of the host vehicle 12.

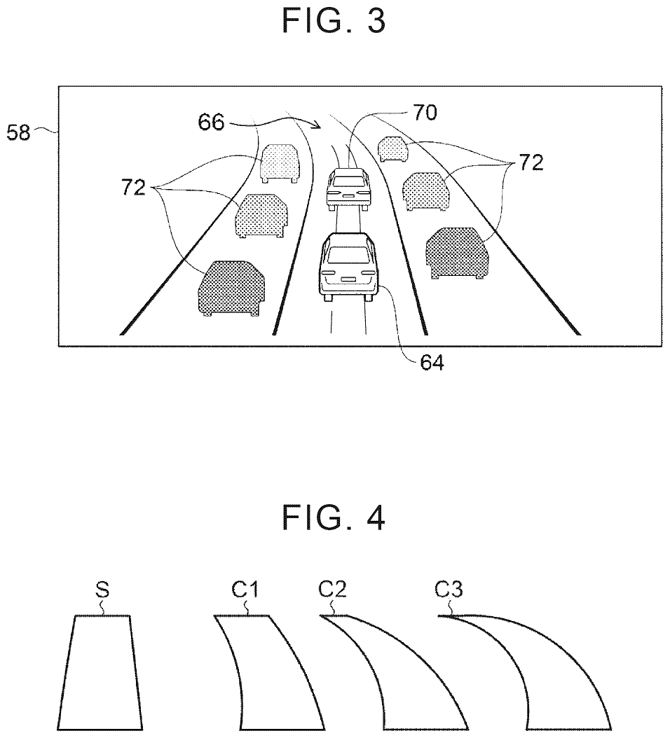

FIG. 3 is a diagram illustrating an example of an image that is displayed on the display device 17 and represents a surrounding state of the host vehicle 12. As shown in FIG. 3, the image 58 displays an image 64 mimicking the host vehicle, an image 66 mimicking the traveling road on which the host vehicle travels, and images 70 and 72 mimicking the surrounding vehicles existing in the vicinity of the host vehicle. In the following description, an image mimicking a traveling road is simply referred to as a “traveling road image”.

When the traveling road on which the host vehicle 12 actually travels is a curved road, as shown in FIG. 3, a curved road is also drawn in the traveling road image 66. Whether or not the actual traveling path is a curved path and its curvature are obtained by processing, for example, an image captured by the camera 14 or point cloud information acquired by the radar device 15 by a known method.

FIG. 4 is a diagram illustrating an example of a traveling road image when a straight road and a curved road are represented. The traveling road image S in FIG. 4 represents that the traveling path is a straight path. In addition, the traveling road images C1 to C3 in FIG. 4 represents that the traveling road is a curved road. The curvature of the curved path drawn in the traveling road image C1, the curvature of the curved path drawn in the traveling road image C2, and the curvature of the curved path drawn in the traveling road image C3 differ from each other. Incidentally, the degree of curvature of the curved path is gentle as the curvature R is larger, the degree of curvature of the curved path is steep as the curvature R is smaller. Therefore, the curvature of the curved path represented by the traveling road image C1 is large, the curvature of the curved path represented by the traveling road image C2 is moderate, and the curvature of the curved path represented by the traveling road image C3 is small. In FIG. 4, a left-turn traveling road image is shown, but a right-turn traveling road image is also prepared in advance.

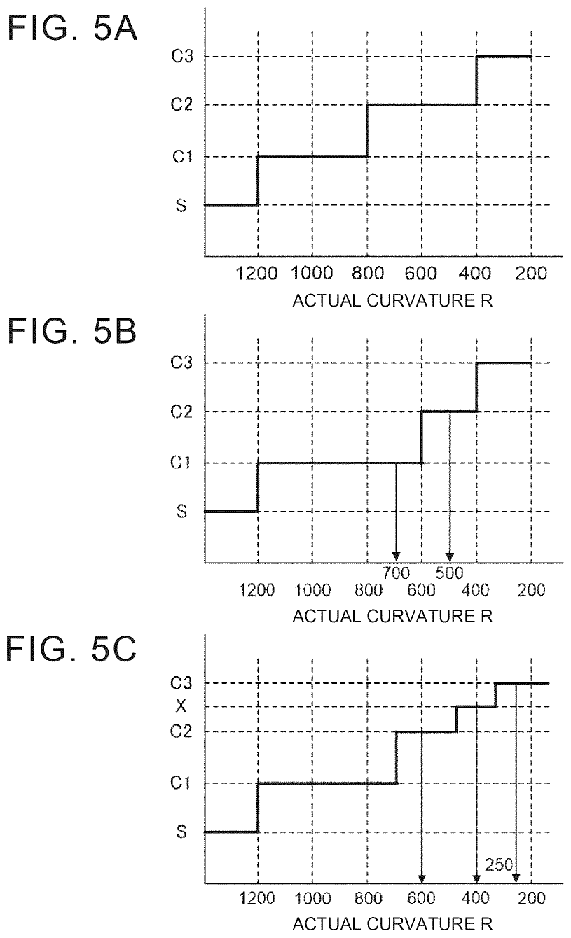

FIGS. 5A to 5C are diagrams for explaining the change in stage of the change in curvature R. As shown in FIG. 5A, in the present embodiment, the curvature of the curved path drawn in the traveling road images is changed stepwise according to the curvature R of the actual curved path. In the embodiment shown in FIG. 5A, when the actual curved path is a left-handed curve and the curvature R is equal to or larger than 1200 m, the traveling road images S of the straight lines in FIG. 4 are displayed on the display device 17. When the curvature R of the actual curved path is equal to or greater than 800 m and less than 1200 m, the traveling road image C1 of FIG. 4 is displayed on the display device 17. When the curvature R of the actual curved path is equal to or greater than 400 m and less than 800 m, the traveling road image C2 of FIG. 4 is displayed on the display device 17. When the curvature R of the actual curved path is equal to or greater than 200 m and less than 400 m, the traveling road image C3 of FIG. 4 is displayed on the display device 17.

However, since the appearance of the curved road varies depending on the occupant, even if the traveling road images are displayed on the display device 17 by gradually changing the curvature as shown in FIGS. 5A to 5C, the occupant of the own vehicle may feel uncomfortable.

Therefore, in the present embodiment, the stage of the change of the curved path is changed based on the driving history data representing the driving history of the host vehicle 12. For example, even in a case where a vehicle is caused to travel on the same curved road, there are a driver that causes the vehicle to travel by gently rotating the steering wheel, and a driver that causes the vehicle to travel by suddenly rotating the steering wheel. Therefore, the vehicle display control device 20 of the first embodiment learns the habit of driving operation of the driver, and changes the stage of change in the curvature of the curve drawn on the driving path image according to the learning result.

Specifically, the vehicle display control device 20 according to the first embodiment allows the driver who causes the vehicle 12 to travel by gently rotating the steering wheel to display on the display device 17 a traveling road image in which a curved path with a gentle bend is drawn. The vehicle display control device 20 of the first embodiment makes it possible to display, on the display device 17, a traveling road image on which a curved road with a sharp bend is drawn, for a driver who makes the steering suddenly rotate and causes the own vehicle 12 to travel.

For example, in the example of FIG. 5A, when the change in curvature is three stages and the traveling path is a curved path, any one of the traveling road image C1, the traveling road image C2, and the traveling road image C3 is displayed on the display device 17. On the other hand, for example, the vehicle display control device 20 according to the first embodiment increases the step of the change in the curvature of the curved road drawn in the traveling road image to five steps for the occupant who drives the own vehicle 12 by suddenly rotating the steering wheel.

In this case, for example, a road image in which the curvature between the curvature represented by the traveling road image C1 and the curvature represented by the traveling road image C2 is expressed and a road image in which the curvature between the curvature represented by the traveling road image C2 and the curvature represented by the traveling road image C3 is expressed are newly prepared. Then, one of the travel path images is displayed on the display device 17 in accordance with the curvature of the actual curved path. Alternatively, for example, a traveling road image in which a curved road having a smaller curvature and corresponding to a curved road having a curvature R of less than 200 shown in FIG. 5A is represented may be prepared, and any one of the traveling road images may be displayed on the display device 17 in accordance with the curvature of the actual curved road.

Further, for example, the vehicle display control device 20 according to the first embodiment reduces the number of stages of change in curvature for a driver who drives the own vehicle 12 by gently rotating the steering wheel. For example, when the change in the curvature is five steps, the change in the curvature R is reduced to three steps. Alternatively, for example, a traveling road image representing a curved road having a larger curvature, which corresponds to a curved road having a curvature R of 1200 or more shown in FIG. 5A, is prepared. Then, any one of the traveling road images may be displayed on the display device 17 in accordance with the curvature of the actual curved road.

This reduces the uncomfortable feeling felt by the driver who is the occupant. Specifically, it is assumed that the driver who drives the own vehicle 12 by suddenly rotating the steering is recognizing a curved road with a steep bend at a high frequency. On the other hand, it is assumed that a driver who drives the own vehicle 12 by gently rotating the steering is recognizing a curved path with a gentle bend at a high frequency. For this reason, in accordance with the steering operation, the driving path image is displayed by increasing or decreasing the number of steps of the change in curvature, thereby reducing the uncomfortable feeling that the driver feels.

The driving history data storage unit 284 sequentially stores driving history data of the driver of the host vehicle 12. Specifically, the driving history data of the first embodiment is the history data of the steering operation of the driver of the host vehicle 12. Therefore, the driving history data storage unit 284 stores the history data of the steering operation obtained from the steering angle θ acquired by the acquisition unit 280. The history data of the steering operation is, for example, a change amount of the steering angle θ within a predetermined time when a curved road is detected in front of the host vehicle 12. According to the magnitude of the change amount of the steering angle θ, it is possible to determine whether the steering operation of the driver is sudden or gradual. Whether or not a curved road exists in front of the host vehicle 12 is detected based on the image captured by the camera 14 and the point cloud information detected by the radar device 15.

The acquisition unit 280 acquires the driving history data of the host vehicle 12 stored in the driving history data storage unit 284. It should be noted that a case where there are a plurality of drivers driving the host vehicle 12 will be considered. In this case, for example, the driver may be identified based on a face image of the driver captured by a driver monitor (not shown) installed in the host vehicle 12 or information stored in a sheet memory (not shown), and the driving history data may be acquired.

Next, the display control unit 282 causes the display device 17 to display an image imitating the host vehicle 12 and a traveling road image when the host vehicle 12 is viewed from the virtual viewpoint. At this time, when the traveling road on which the host vehicle 12 travels is a curved road, the display control unit 282 changes the stage of the change in the curvature of the curved road drawn in the traveling road image in accordance with the driving history data acquired by the acquisition unit 280. Note that the display control unit 282 calculates a curvature R of a traveling road on which the host vehicle 12 travels (for example, a traveling road ahead of the host vehicle 12), and determines whether or not the traveling road on which the host vehicle 12 travels is a curved road. In addition, the display control unit 282 increases the step of the change in the curvature when the amount of change in the steering operation represented by the driving history data is large (for example, when the amount of change is equal to or larger than a predetermined first threshold value). On the other hand, when the amount of change in the steering operation represented by the driving history data is small (for example, when the amount of change is equal to or smaller than a predetermined second threshold value), the display control unit 282 decreases the step of change in the curvature.

Then, the display control unit 282 causes the display device 17 to display the traveling road image corresponding to the curvature of the actual curved path, based on the step of the change of the curvature set above. Specifically, the display control unit 282 causes the display device 17 to display the traveling road image corresponding to the curved road on which the host vehicle 12 travels, together with the image simulating the host vehicle 12, in the stage in which the stage of change in curvature is changed.

### Actions

Next, the operation of the vehicle display control system 10 of the present embodiment will be described.

### Vehicle Display Control Process

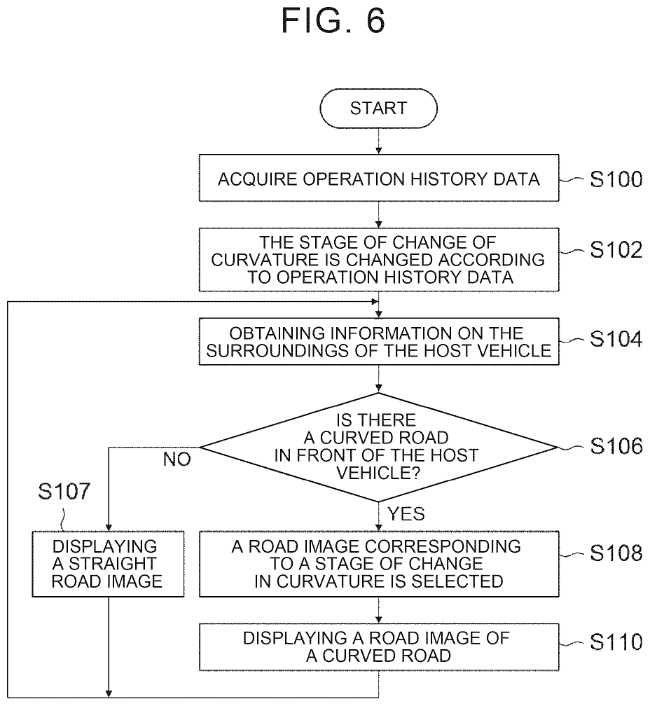

The vehicle display control device 20 executes the vehicle display control processing routine shown in FIG. 6. This vehicle display control process is executed by CPU 30 reading out the vehicle display control program from ROM 32 or the storage 36, expanding the program into a RAM 34, and executing the program.

In S100, the acquisition unit 280 acquires the history data of the steering manipulation, which is the driving history data stored in the driving history data storage unit 284.

In S102, the display control unit 282 changes the stage of the change in the curvature of the curved path drawn in the traveling road image in accordance with the history data of the steering operation which is the driving history data acquired by S100. For example, the display control unit 282 increases or decreases the stage of the change in the curvature of the curved path in accordance with the historical data of the steering operation.

In S104, the display control unit 282 acquires the surrounding information of the host vehicle 12 including the images captured by the cameras 14 and the point group information detected by the radar device 15. Further, the display control unit 282 calculates the curvature R of the traveling road ahead of the host vehicle 12 based on the surrounding information.

In S106, the display control unit 282 determines whether or not there is a curved road in front of the host vehicle 12 based on the curvature R of the traveling road in front of the host vehicle 12 calculated by S104. Note that the display control unit 282 determines whether or not there is a curved road in front of the host vehicle 12 by thresholding the curvature R of the traveling road in front of the host vehicle 12 calculated by S104. If there is no curved path in front of the host vehicle 12, the process proceeds to S107. On the other hand, if there is a curved road in front of the host vehicle 12, the process proceeds to S108.

In S107, the display control unit 282 causes the display device 17 to display a traveling road image in which the traveling path is represented by a straight line. For example, the traveling road image S shown in FIG. 4 is displayed on the display device 17.

In S108, the display control unit 282 selects the traveling road images of the curved road that are applicable to the stage of the change of the curvature changed by S102. For example, as shown in FIG. 5A, when the curvature R of the curved road existing in front of the host vehicle 12 calculated by S104 is R=600, the traveling road image C2 is selected.

In S110, the display control unit 282 causes the display device 17 to display the road images selected by S108.

As described above, the vehicle display control device of the first embodiment acquires the driving history data of the host vehicle. The vehicle display control device displays, on the display device, an image imitating the host vehicle and a traveling road image when the host vehicle is viewed from a virtual viewpoint. When the traveling path on which the host vehicle travels is a curved path, the vehicle display control device changes the stage of the change of the curved path curvature drawn in the traveling road image in accordance with the driving history data. Then, the vehicle display control device causes the display device to display the traveling road image corresponding to the curved road on which the host vehicle travels in the changed stage. Accordingly, when an image representing a surrounding situation of the host vehicle is presented to the occupant of the host vehicle in a situation where the host vehicle travels on a curved road, it is possible to reduce the uncomfortable feeling of the occupant.

### Second Embodiment

Next, a second embodiment will be described. The driving history data of the second embodiment is historical data of the traveling road on which the host vehicle travels, and the vehicle display control system of the second embodiment is different from the first embodiment in that the stage of the change in the curvature of the curved road is changed based on the historical data of the traveling road. Note that the configuration of the vehicle display control system of the second embodiment is the same as that of the vehicle display control system 10 of the first embodiment, and thus description thereof will be omitted.

The vehicle display control device of the second embodiment learns what the driving path self-vehicle 12 is driving many, and changes the stage of change of the curvature of the curve in accordance with the learning result. Therefore, the driving history data in the second embodiment is the history data of the traveling road on which the host vehicle 12 has traveled. The history data of the traveling path is collected, for example, on the basis of an image captured by the camera 14 while the host vehicle 12 is traveling and point cloud information detected by the radar device 15. Specifically, by analyzing the image captured by the camera 14 and the point cloud information detected by the radar device 15 by a known method, the curvature R of the curved road on which the host vehicle 12 actually travels is acquired and stored in the driving history data storage unit 284. Alternatively, the curvature R of the curved path actually traveled by the host vehicle 12 is acquired on the basis of the position information acquired by GPS device mounted on the host vehicle 12 and the map data reflecting the information on the curvature of the curved path, and is stored in the driving history data storage unit 284.

For example, suppose that the historical data of the curvature R of the curved road on which the host vehicle 12 actually travels indicates that the frequency of the curved road of R=700 m and the frequency of the curved road of R=500 m are higher. In this case, the display control unit 282 changes the stage of the change of the curvature shown in FIG. 5A to the stage of the change of the curvature shown in FIG. 5B so that the two curved paths can be identified. As a result, the traveling route image of R=700 m and the traveling route image of R=500 m that the host vehicle 12 normally travels are adjusted to be different images. Therefore, the curved path of R=700 m and the curved path of R=500 m can be identified on the display device 17, and it is possible to reduce the feeling of discomfort to the occupant.

Or, for example, suppose that the historical data of the curvature R of the curved path actually traveled by the host vehicle 12 indicates that the frequency of the curved path of R=600 m, the frequency of the curved path of R=400 m, and the frequency of the curved path of R=250 m are higher. In this case, the display control unit 282 increments the step of the change of the curvature to four steps, as shown in FIG. 5C, so that the three curved paths can be identified. In this case, as shown in FIG. 5C, the traveling road images X are newly prepared. This makes it possible to distinguish the curved road of R=600 m, the curved road of R=400 m, and the curved road of R=250 m on the display device 17, in which the host vehicle 12 normally travels a lot, and thus it is possible to reduce the feeling of discomfort for the occupant.

As described above, the vehicle display control device of the second embodiment changes the stage of the change of the curved road curvature based on the historical data of the traveling road on which the host vehicle travels. Accordingly, it is possible to reduce the sense of discomfort felt by the occupant of the host vehicle. Specifically, since the occupant of the host vehicle 12 can identify the difference in the curved road on which the host vehicle 12 normally travels, it is possible to reduce the sense of discomfort when the occupant sees the traveling road image.

Although the vehicle display control system 10 according to each embodiment has been described above, it is needless to say that the present disclosure can be implemented in various forms without departing from the gist of the present disclosure.

For example, various processors other than CPU 30 may execute a process executed by CPU 30 reading the program in the above-described embodiment. Examples of the processor in this case include a dedicated electric circuit or the like which is a processor having a circuit configuration designed exclusively for executing a specific process. Circuit configurations specifically designed to perform a particular process are, for example, Field-Programmable Gate Array (FPGA) or other Programmable Logic Device (PLD) in which the circuit configuration can be changed after manufacturing, and Application Spec Integrated Circuit (ASIC). Further, the processing described above may be executed by one of the various processors, or a combination of two or more processors of the same category or different categories, for example, a plurality of FPGAs and a combination of a CPU and a FPGA. Further, a hardware structure of the various processors is, more specifically, an electric circuit in which circuit elements such as semiconductor elements are combined.

Further, in the above-described embodiment, the storage 36 is configured to store various data, but the present disclosure is not limited thereto. For example, a non-transitory recording medium such as Compact Disk (CD), Digital Versatile Disk (DVD), and Universal Serial Bus (USB) memories may be used as the storage unit. In this case, various programs, data, and the like will be stored in these recording media.

Further, the flow of the processing described in the above embodiment is an example, and unnecessary steps may be deleted, new steps may be added, or the processing order may be changed within a range not departing from the gist.

What is claimed is:

1. A vehicle display control device comprising:
an acquisition unit configured to acquire driving history data of a host vehicle; and
a display control unit configured to, when a traveling road on which the host vehicle travels is a curved road, change stages of variation in a curvature of the curved road to be shown in an image imitating the traveling road according to the driving history data, and causes a display unit to display, together with an image imitating the host vehicle, an image imitating the traveling road that is associated with the curved road on which the host vehicle travels among the changed stages.

2. The vehicle display control device according to claim 1, wherein:
the driving history data is history data of steering operations of a driver for the host vehicle; and
the display control unit is configured to change the stages of the variation in the curvature based on the history data of the steering operations.

3. The vehicle display control device according to claim 1, wherein:
the driving history data is history data of traveling roads on which the host vehicle has traveled; and
the display control unit is configured to change the stages of the variation in the curvature based on the history data of the traveling roads.

4. A vehicle display control method comprising causing a computer to execute a process including:
acquiring driving history data of a host vehicle; and
when a traveling road on which the host vehicle travels is a curved road, changing stages of variation in a curvature of the curved road to be shown in an image imitating the traveling road according to the driving history data, and causing a display unit to display, together with an image imitating the host vehicle, an image imitating the traveling road that is associated with the curved road on which the host vehicle travels among the changed stages.

5. A vehicle display control program for causing a computer to execute a process including:
acquiring driving history data of a host vehicle; and
when a traveling road on which the host vehicle travels is a curved road, changing stages of variation in a curvature of the curved road to be shown in an image imitating the traveling road according to the driving history data, and causing a display unit to display, together with an image imitating the host vehicle, an image imitating the traveling road that is associated with the curved road on which the host vehicle travels among the changed stages.
